(19) United States
(12) Patent Application Publication
(10) Pub. No.: US 2018/0001321 A1
(43) Pub. Date: Jan. 4, 2018

(54) REACTOR AND PROCESS FOR PRODUCING NANOFIBERS AND METHOD OF USING NANOFIBERS IN WEB-FORMING TECHNIQUES

(71) Applicant: Evan KOSLOW, Dallas, TX (US)

(72) Inventor: Evan KOSLOW, Dallas, TX (US)

(21) Appl. No.: 15/538,772

(22) PCT Filed: Dec. 22, 2015
(86) PCT No.: PCT/US15/67340

§ 371 Date: Jun. 22, 2017

Related U.S. Application Data
(60) Provisional application No. 62/095,354, filed on Dec. 22, 2014.

(51) Int. Cl. B02C 13/26; D21F 1/00; B02C 13/18; D21D 1/34; D21F 11/00; D21F 9/00

(52) U.S. Cl. CPC B02C 13/26; D21F 11/00; D21F 9/00; B02C 13/18; D21D 1/34; D21F 1/00

(57) ABSTRACT

A process for fibrillating a fibrous pulp, and products made using the same. The process comprises providing a fibrous pulp of liquid and staple fibers having a first liquid to fibers ratio of less than or equal to 6:1, applying stress to the pulp to fibrillate the staple fibers; and, during said applying stress, drying the pulp to a second liquid to staple fibers ratio of less than or equal to 0.43:1.

### FIELD

This disclosure relates to the field of reactors and processes for producing nanofibers and methods of using nanofibers in web-forming techniques.

### INTRODUCTION

Fibrillation of fibers has been carried out for centuries. A common example is the beating of natural cellulose-based materials to obtain wet-laid papers with improved properties. Fibrillation, as defined herein, is the peeling away of fibrils through the application of mechanical stress against fibers that are swollen with a liquid, such as water, a water-solvent mixture, a salt solution, or an alkaline agent, for example.

### DRAWINGS

FIG. 1 is a perspective view of a reactor for defibrillating fibrous pulp; and

FIG. 2 is a graph illustrating a process for defibrillating fibrous pulp.

### DESCRIPTION OF VARIOUS EMBODIMENTS

Fibrillation of synthetic cellulose, such as commercial Lyocell, or commercial acrylic fibers has historically been seen as undesirable for textiles where launderability and toughness are desired, and during many textile production operations. However, in the production of fine nonwovens, fibrillation may have application for producing fine fibers which may be used for fine filtration, within barrier fabrics, or for the production of fibrous membranes, for example.

Early work on the use of fibrillated fibers for filtration include that of Giglia et al. (U.S. Pat. Nos. 4,565,727; 4,904,343; 4,929,502; 5,180,630; and 5,192,604) relating to acrylic fibers in combination with activated carbon fibers, activated carbon powders, other fine fibers such as spun glass, and other adsorbents useful for the adsorption of toxic agents.

Later, the fibrillation of synthetic cellulosic fibers that are manufactured by dissolution of purified wood pulp in an amine oxide solvent and spinning this “dope” through spinnerets into continuous, highly oriented yarn was studied by a wide range of groups. Such fiber, commercially called Lyocell, has a high tendency to fibrillate when exposed to stress while swollen with water, solvents, salts and some alkaline agents.

The most common approach to the fibrillation of Lyocell is to disperse the fiber (reduced in length to generally less than 6 mm) as a slurry of 2-4% fibers by weight in water and pass this slurry through a beater, various refiners, or the rotor of a machine such as a Daymax for a time sufficient to cause fibrillation and obtain a measurable reduction in the Canadian Standard Freeness (CSF) of the fiber. The fiber size in the slurry may be deduced from the CSF measurement.

Koslow and Suthar (U.S. Pat. No. 7,566,014) explore various means to optimize the “open channel” refining of Lyocell fiber using a sequence of increasing shear within a sequence of reactors. The purpose here was to optimize the fibrillation process, while minimizing energy consumption. Koslow reports that beating and refining of such fibers results in severe reduction of fiber length, which is undesirable in many applications, whereas use of “open channel” machines avoided significant fiber length reduction while obtaining a reduction of CSF from 700 in the original fiber to roughly zero in the final product.

Koslow and Suthar (U.S. Pat. No. 8,444,808) further suggest the use of a final “closed channel” refining or homogenizing step to separate fibrils from the original core fiber and to obtain a nearly pure nanofiber-size material. Koslow also suggests a wide range of wet-laid nanofiber structures in combination with other structures and materials (see for example U.S. Pat. Nos. 7,655,112; 6,550,622; and 6,797,167). Miller et al. (U.S. Pat. No. 8,540,846) also propose the use of such fibers for the production of various products and creped sheets.

Above roughly 4% solids by weight, a fiber slurry may form a thick gel that will not circulate within the refiners, high-intensity mixers, or beaters of the prior art processes. Accordingly, prior art methods of fibrillating fibers may be limited to fibrillating fiber slurries of approximately 4% solids by weight or less. However, as explained below, it may be inefficient and unproductive to fibrillate a fiber slurry with such a low fiber content by weight (i.e. high liquid content).

There is an inverse correlation between the energy efficiency of a fibrillation process, and the liquid content by weight of the slurry being processed. Much of the mechanical energy applied to process a slurry having a high liquids content by weight (i.e. low solids content by weight) may be wasted in shearing and mixing the fluid medium instead of being applied to exerting stress on the fibers to cause fibrillation. For example, a slurry of 25% solid fiber content may fibrillate with nearly ten times less energy input per unit of fiber weight than a slurry containing only 3% solids. Accordingly, it is generally desirable to fibrillate a slurry containing a high solids content by weight. Of course, there may be an upper limit to the solids content that may be fibrillated, as a sufficient quantity of liquid may be required to swell the fibers for rendering the fibers susceptible to fibrillation.

Prior art fibrillation processes may output pulp requiring immediate use or expensive dewatering. Specifically, the output pulp may have the same or similarly high liquids content by mass as the input slurry. Even exhaustive effort with vacuum or pressure dewatering may fail to mechanically reduce water content of the output pulp to below about 85% liquids by weight (i.e. above 15% solids by weight) when the fibers have CSF values of <10. Accordingly, the output pulp remains physically wet and may support the rapid development of pink mold and other microbiological contamination. Therefore, the output slurry may require immediate use or disposal. An alternative is to dry the output pulp using a flash dryer or similar technology, but drying pulp that is 85% liquid by weight requires significant energy expenditure. The energy cost may make such drying impractical.

The usefulness of wet output pulp from prior art processes may be limited. For example, the pulp fibers may readily disperse in liquid making the pulp suitable for wet-laid and paper making processes. However, the wet output pulp may be practically unusable in a dried condition. The nano fibers in the pulp have very high aspect ratios. When dried, these fibers form a hard entangled mat. Hammer milling the dried pulp may result in massive shattering of the fibers into short lengths (possibly to dust) that may be no longer useful for most downstream processes, such as carding. This may make the output pulp of prior art processes unsuitable for downstream processes such as air laid and carding processes which may require dry and substantially disentangled pulp.

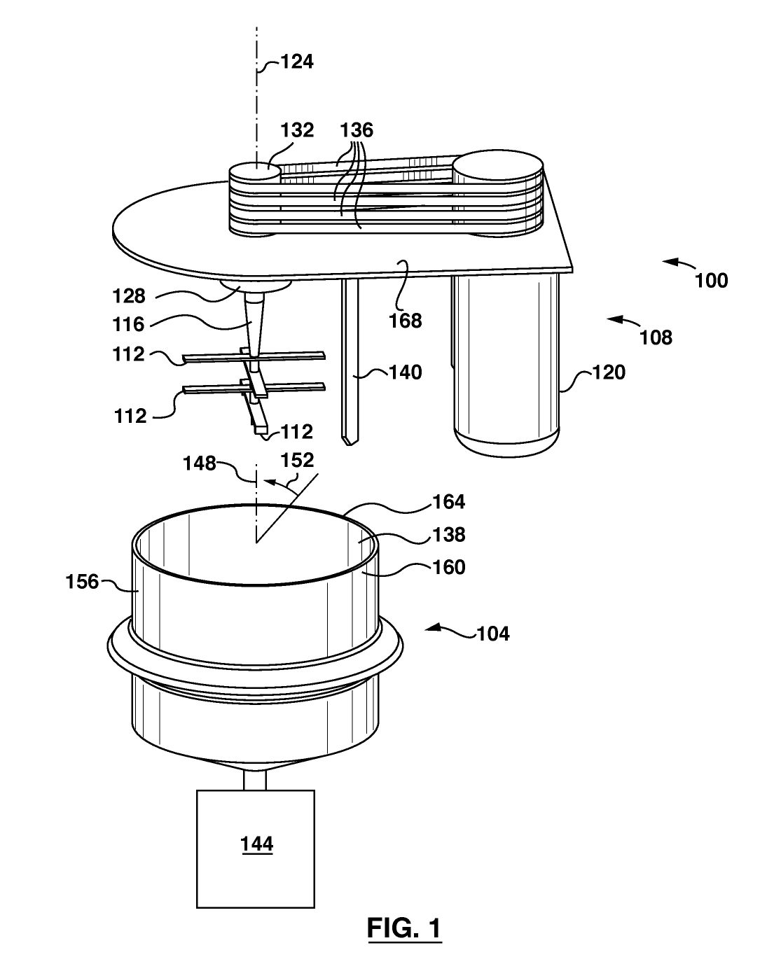

Referring to FIG. 1, a fibrillation reactor 100 is shown in accordance with at least one embodiment. As illustrated, reactor 100 may include a vessel, such as pan 104, for holding fiber pulp during processing, and a mixer 108 for imparting stress and mechanical energy to the pulp. Preferably, reactor 100 is compatible with fibrillating input pulp at or below the swell ratio of the pulp. However, the input pulp should have sufficient liquid that the pulp fibers become susceptible to fibrillation from swelling.

In some examples, the input pulp may include 10-40% fibers by weight (i.e. 60-90% liquid) and more preferentially 20-30% fibers by weight (i.e. 70-80% liquid). This may provide up to a 95% reduction in the mass ratio of liquid to fibers in the input pulp compared with prior art processes having input slurries of 2-4% fibers by weight (i.e. 96-98% liquid by weight). For example, pulp having 30% fibers by weight has a liquid to fibers mass ratio of 2.3:1, whereas a slurry having 2% fibers by weight has a liquid to fibers mass ratio of 49:1. Generally, the fluid level may be as low as required to render the pulp susceptible to fibrillation. Many types of fibers are resistant to fibrillation when dry, and become susceptible to fibrillation at or above a minimum liquid content by weight (the “Fibrillation Liquid Limit” of the fiber). Preferably, the input pulp has between 100-200% of the Fibrillation Liquid Limit, more preferably 100%-150%, and most preferably 100%-125%.

Preferably, reactor 100 is configured to circulate the input pulp during processing to impart stress substantially uniformly to the entire quantity of input pulp. In the illustrated example, mixer 108 includes a plurality of arms 112 extending from a rotor 116. Rotor 116 may be positioned to extend into pan 104 for bringing arms 112 in contact with the pulp inside. Reactor 100 may provide relative motion between arms 112 and the pulp to apply stress to the pulp by impact with arms 112. For example, one or more of rotor 116 and mixer 108 may be driven to rotate.

Rotor 116 may be driven to rotate in any suitable fashion. For example, a motor 120 may be drivingly coupled to rotor 116 for driving rotor 116 to rotate about an axis 124 of rotation. Rotor 116 may be directly or indirectly driven by motor 120. In the illustrated example, rotor 116 is indirectly driven by motor 120. As shown, rotor 116 may be mounted to a spindle 128 connected to a sheave 132. One or more drive belts 136 may connect rotor sheave 132 to a sheave 140 on the output shaft of the motor 120.

Optionally, rotor 116 may be driven at a higher speed than the output speed of motor 120. For example, rotor 116 may be driven at 5,000 RPM and the output speed of motor 120 may be 3,450 RPM. As illustrated, the speed increase may be provided by sizing rotor sheave 132 smaller than motor sheave 140. In alternative embodiments, rotor 116 may be driven at the same speed as motor 120, or at a greater speed than motor 120. Also, in some embodiments, the speed differential may be accomplished in another suitable fashion such as by a gearbox between rotor 116 and motor 120 for example.

Rotor 116 may have any suitable number of arms 112 for impacting the pulp. In the illustrated example, rotor has eight arms 112 which extend from rotor 116 perpendicularly to rotor axis 124. In alternative embodiments, rotor 116 may include fewer or more than eight arms 112 (e.g. 1-50 arms), and each arm may extend normal to rotor axis 124 or at another angle to rotor axis 124 (e.g. 15-90 degrees to rotor axis 124).

In some cases, the pulp in pan 104 may be semi-solid and stick persistently to the sidewalls 138 of pan 104. Preferably, reactor 100 is configured to recirculate pulp from the sidewalls 138 inwardly to promote homogenous fibrillation by impact with arms 112. In the illustrated example, reactor 100 includes a doctor blade 140 positioned radially outboard of arms 112 for scraping the sidewalls 138 of pan 104. The doctor blade 140 may separate pulp adhered to the sidewalls 138 for moving the pulp radially inwardly for impact with arms 112.

Doctor blade 140 may be movable along the sidewall 138 of pan 104. For example, doctor blade 140 may be drivingly coupled to motor 120 or another motor for rotating about the sidewall 138 of pan 104. Alternatively, doctor blade 140 may be stationary as shown, and pan 104 may be rotatable. For example, pan 104 may be drivingly coupled to a motor 144 for rotation about a vessel axis 148. Vessel axis 148 may be parallel to rotor axis 124. In the illustrated example, vessel axis 148 is parallel and linearly offset from rotor axis 124. In alternative embodiments, rotor axis 124 may be collinear with vessel axis 148, or extend at a (non-zero) angle to vessel axis 148.

Optionally, pan 104 may be oriented at an angle for promoting pulp to move toward a center of the pan 104. For example, vessel axis 148 may extend at a (non-zero) angle 152 to vertical. In the illustrated example, angle 152 is approximately 45 degrees. Preferably, angle 152 is 10-90 degrees, more preferably 25-75 degrees, and most preferably 30-60 degrees to vertical. When oriented at an angle to vertical as shown, pan 104 may include a lower sidewall portion 156 and an upper sidewall portion 160. Pulp adhered to the sidewall 138 of the pan 104 may fall by gravity from the upper sidewall portion 160 inwardly toward the center of the pan 104. Preferably, pan 104 is rotatable about vessel axis 148 for continuously moving pulp adhered to the sidewall 138 to the upper portion 160 of the pan 104. More preferably, doctor blade 140 may be positioned in the upper portion 160 for scraping pulp off of the upper sidewall portion 160. As the pulp is scraped off, it may fall back into the center of the pan 104 by gravity for further fibrillation by impact with arms 112.

In some embodiments, pan 104 may include an open end 164. Preferably, end 164 is openable for depositing pulp to be fibrillated into the pan 104 and for withdrawing the pulp after fibrillation. Optionally, end 164 may be selectively closed by a closure. In the illustrated embodiment, a plate 168 is positionable over end 164 for closing end 164. As shown, rotor 116 and motor 120 may be mounted to plate 168.

As exemplified, reactor 100 may accommodate a pulp material that is not a free-flowing suspension and may, therefore, successfully fibrillate a pulp slurry of very high solids content.

Preferably, reactor 100 may fibrillate acrylic, Lyocell, or other suitable synthetic or natural fibers with a minimum amount of swelling fluid required to make the fibers susceptible to fibrillation. This may reduce the energy consumption per mass of fiber. Reactor 100 preferably produces a dry fibrillated nanofiber product suitable for wet and dry applications without significantly reducing the length of the fibers. The dry fiber product is preferably suitable for wet-laid applications, as well as air laid, carding and other applications where a dry fiber is required. The dry fiber product is preferably a fluff pulp where the integrity of the individual fibers is retained and where fiber entanglement is greatly reduced compared with drying the wet product of prior art processes. This may permit the fibers to be readily dispersed into blending and air dispersion processes for use in numerous nonwovens processes. This may also make the dry fibers stable, resistive to microbiological attack, and therefore suitable for shipping long distances without incurring the expense of shipping a large mass of associated water.

Reactor 100 may be operable to produce a dry fibrillated nanofiber product. The tilted rotating reactor may cause the moist mass to be continuously passed through the high-speed rotor spinning within the reactor. The placement of the rotor adjacent to the vessel sidewall and the use of a fixed doctor blade may cause the slurry to be continuously moved from the wall to the interior of the reactor. This may promote continuous exposure of substantially all of the slurry to the action of the high-speed rotor arms.

Where the reactor 100 is used to process pulp having a modest amount of swelling fluid (e.g. water), the physical action of the rotor arms may be sufficient to cause rapid heating of the pulp so that the pulp rises to the boiling point of liquid within a short time. This may produce steam from the pulp liquid which may be continuously released from the reactor as the reactor processes the fiber. Without being limited by theory, the high-temperature processing appears to accelerate the swelling and fibrillation of the fibers in many cases.

Preferably, liquid may be added to the reactor to maintain the fiber susceptibility to fibrillation from swelling. For example, the amount of moisture within the reactor may be maintained at a level approximately equal to or less than the original moisture content at the start of the process. Later, the rate of liquid addition may be reduced or eliminated to allow the liquid to flash to steam for producing a dry final product. Preferably, the final product is greater than 75% fibers by weight, more preferably greater than 80% fibers by weight, and most preferably greater than 85% fibers by weight.

Preferably, the rotor arms continue to impact the reactor contents while the liquid is evaporated. The action of the rotor arms during this period may convert the nanofiber pulp into a low-density fluff including small fiber flocs. The final product may be a dry, low-density fluff ready for immediate injection into air laid, carding, or other dry-fiber processing systems or that can added to water and immediately disperses without difficulty for wet-laid applications. Preferably, the bulk density of the final pulp product is less than 0.2 g/cm³, more preferably less than 0.1 g/cm³, and most preferably less than 0.05 g/cm³.

For shipping, the dry low-density pulp product may be vacuum packed into plastic bags, which may cause the pulp to collapse to a much higher density. When the vacuum is released, the pulp may be restored to its previous low-density, loose fluffy character.

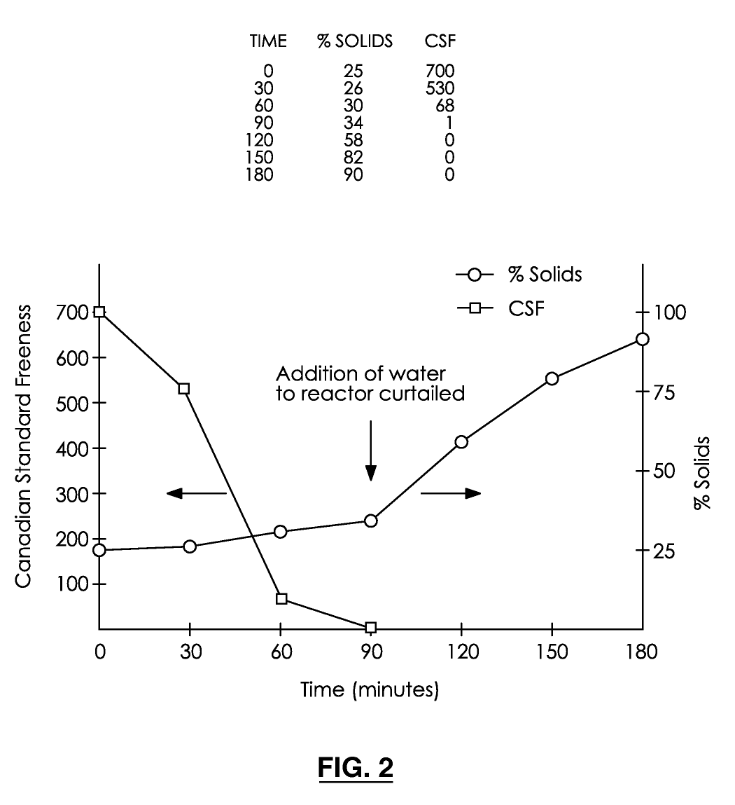

FIG. 2 shows a graph illustrating a process of fibrillating a fibrous pulp in accordance with at least one embodiment. As exemplified, the process begins at t₀ where the solids content of the pulp may be held substantially constant or allowed to increase slightly through continuous addition of water (or another suitable swelling liquid) at or slightly below the rate of water evaporation. During this period, fiber size, as deduced indirectly from the Canadian Standard Freeness (CSF) of the pulp, is rapidly reduced. Once the pulp has achieved a target CSF at t₁, the rate of addition of water is reduced further to substantially less than the rate of water evaporation (or stopped altogether) and the water within the reactor is allowed to flash off to leave a dry (e.g. less than 25% moisture), low-density (e.g. less than 0.2 g/cm³), fluffy pulp that has expanded to fill the entire reactor volume at t₂.

### Example 1

Still referring to FIG. 2, a reactor having a roughly 1 cubic foot total volume is loaded with 1.0 kg of dry Lyocell chopped fiber with an average fiber length of 6 mm. To this fiber is added 3.0 liters of water to provide a fibrous pulp with 25% Lyocell fibers by weight and 75% water by weight. In other examples, the input pulp may include between 15% and 30% fiber by weight.

The rotor is operated at 4500 RPM and the pan is allowed to rotate at a rate of approximately 30 RPM. The initial CSF of the fiber is approximately 700 at t₀. Until t₁ (e.g. during the first 90 minutes of operation), water is added to the reactor at a rate of approximately 15 mL per minute to sustain the pulp contents in a saturated condition. The reactor may heat the pulp contents to the boiling point of water in approximately 20-25 minutes, at which point visible steam emerges continuously thereafter.

As illustrated, at the end of the first 30 minutes of operation the CSF of the pulp is reduced to approximately 530 and the moisture content may be essentially unchanged at 25%. At 60 minutes, the pulp has a CSF of approximately 68 and the solids content has increased to 28% because the rate of evaporation has slightly outpaced the rate of water input.

The pulp may now have a wet sticky appearance, and no residual free water may be visible having been fully adsorbed by the pulp or been boiled off. At t₁ (e.g. at 90 minutes as shown), the CSF of the pulp is assayed at a value of 1.0 and the solids content has further increased to 33%. At this point, the addition of water is curtailed and the pulp is allowed to continue processing under the same conditions for an additional 60 minutes to t₂. At this point the bulk density of the pulp has collapsed to a value of approximately 0.05 g/cm³ (the pulp has expanded to fill the entire reactor), moisture content is only 18% and the CSF of the pulp is zero or less. The resultant fiber has a broad fiber diameter range of 50-1000 nm, with an average fiber diameter of approximately 400 nm.

The resulting pulp may be easily incorporated into carded products by direct injection of the low-density pulp into the blender of such equipment. The pulp may be highly wettable and disperse immediately when added to a furnish destined for use in a paper machine. The pulp may be light and fluffy and easily metered into conventional air laying equipment. Also, the pulp may be incorporated more securely into a web using hydroentanglement and needle punching methods.

The pulp of the disclosed process is very different from prior art nanofiber pulps. For example, the pulp may be completely friable, and the fibers may be substantially disentangled. This may allow the fibers to be dispersed in air, water, or solvents, and metered using a variety of fiber feeding machines. Prior art pulps resisted hammer milling as this resulted in a significant reduction in fiber integrity and length. Hammer milling may be generally unnecessary with the disclosed pulp product; the pulp may disperse immediately within a moving stream of air. The pulp may have a superficial similarity to goose down or similar low-density fibrous materials.

The energy cost and production rate of the presently disclosed process may be substantially less than the prior art processes. For example, in accordance with at least one execution of the present process, the energy consumption may be approximately 0.8 kW and the CSF of the processed Lyocell may have dropped to <2 in under than 90 minutes. At this very low CSF value, effectively all of the pulp has been reduced to less than 1 micrometer in diameter and the majority is below 500 nm. Therefore, the process may require only 1.2 kW-hr to fibrillate 1 kg of Lyocell into nanofiber. This provides an energy cost of approximately $0.12/kg of fiber (calculated at $0.10/kW-hr).

In contrast, a 660 gallon capacity prior art machine (having approximately 500 gallons of usable capacity) loaded with a 3% solids by weight fiber slurry may process approximately 54 kg of fiber, in 8 hours, and consume approximately 800 kW-hrs of energy at a cost of approximately $80 (calculated at $0.10/kW-hr). This equates to approximately an energy cost of $1.48/kg of fiber, which is over 10 times more than the example of the present process above.

Additionally, the nanofibers of the presently disclosed process may be dried and preserved in a form suitable for dispersion in dry-laid or carding processes for an additional energy cost of approximately $0.09/kg of fiber, and an additional 1-hour processing within the reactor. This may provide stable fibers that are biologically inert, and easy to handle, transport, and disperse. The additional hour of processing may further reduce the fiber diameter, although this may be limited by the macro-fibril limit of the fiber material. For example, Lyocell has a macro-fibril limit of approximately 500 nm which makes Lyocell's intrinsic structure difficult to shatter below 500 nm.

In some embodiments, the drying of the fiber may be further enhanced by application of heat to the reactor vessel or through the injection of hot air into the reactor vessel. Rapid agitation of the reactor contents by the spinning rotor and the continued induced motion caused by the spinning of the reactor vessel may provide efficient heat transfer whether said heat is injected through the vessel wall or through the use of hot air injected into the vessel during operation.

The resulting low-density nanofiber pulp may be added in varying amounts to dry-laid and carded webs to obtain improved filtration. The fibers may be treated to achieve hydrophobic or oleophobic properties, which may provide improved barrier properties to fabrics, may provide improved coalescing behavior, or may produce nonwovens with high vapor transmission but controlled fluid penetration. Additives may be injected into the reactor before or during processing to adjust these properties or to enhance microbiological resistance, microbiological adhesion, electrostatic attraction, electrostatic dissipation, or any number of other properties.

In some embodiments, the nanofiber pulp may be incorporated into a coating or applied as a spray or within a second head box of a paper machine either alone or with other fibers and additives to create a coated wet-laid sheet. In some embodiments, the nanofiber pulp may be directly metered into the process using traditional blending and metering equipment.

1. A process for fibrillating a fibrous pulp, the process comprising:
providing a fibrous pulp of liquid and staple fibers having a first liquid to fibers ratio of less than or equal to 6:1;
applying stress to the pulp to fibrillate the staple fibers; and
during said applying stress, drying the pulp to a second liquid to staple fibers ratio of less than or equal to 0.43:1.

2. The process of claim 1, wherein:
said providing comprises depositing said fibrous pulp into a vessel of a fibrillation reactor, and
said applying stress comprises impacting the fibers with a rotor of the reactor.

3. The process of claim 1 or claim 2, wherein:
said drying comprises heating the liquid by mechanical energy to a temperature above the boiling point of the liquid.

4. The process of any preceding claim, wherein:
said drying comprises raising the temperature of the liquid above the boiling point of the liquid by mechanical impaction of the pulp with a rotor.

5. The process of any preceding claim, further comprising:
expanding the pulp to a bulk density of less than 0.2 g/cm³.

6. The process of any preceding claim, wherein:
the fibrous pulp forms a substantially non-flowing mass during said applying stress.

7. The process of claim 6, wherein:
said providing comprises depositing said fibrous pulp into a vessel of a fibrillation reactor, and
said applying stress comprises scraping the fibrous pulp off of sidewalls of the vessel and impacting the pulp with a rotor of the reactor.

8. The process of claim 7, wherein:
said scraping comprises rotating the vessel to move fibrous pulp adhered to the sidewalls into scraping contact with a stationary doctor blade.

9. The process of any preceding claim, wherein:
said drying comprises removing all free liquid from the pulp by at least one of evaporation or adsorption by the fibers.

10. A process for fibrillating a fibrous pulp having a Fibrillation Liquid Limit, the process comprising:
providing a fibrous pulp of liquid and staple fibers having a first liquid content by weight of between 100-200% of the Fibrillation Liquid Limit of the staple fibers;
applying stress to the pulp to fibrillate the staple fibers; and
during said applying stress, drying the pulp to a second liquid to staple fibers ratio of less than or equal to 0.43:1.

11. The process of claim 10, wherein:
the first liquid content is between 100-150% of the Fibrillation Liquid Limit.

12. The process of claim 10 or claim 11, wherein:
the first liquid content is between 100-125% of the Fibrillation Liquid Limit.

13. A reactor for fibrillating fibrous pulp, the reactor comprising:
a vessel for holding the fibrous pulp, the vessel having a vessel axis extending at an angle to vertical,
a rotor having at least one arm extending into the vessel for impacting the fibrous pulp, and
a motor drivingly coupled to the rotor for rotating the rotor.

14. The reactor of claim 13, further comprising:
a second motor drivingly coupled to the vessel for rotating the vessel about the vessel axis.

15. The reactor of claim 13 or claim 14, further comprising:
a doctor blade positioned in close proximity to a sidewall of the vessel for scraping the fibrous pulp off of the sidewall.

16. The reactor of claim 15, wherein:
the vessel comprises an upper sidewall portion positioned above a lower sidewall portion, and
the doctor blade is positioned in close proximity to the upper sidewall portion.

17. A fibrillated fiber pulp product comprising:
a plurality of substantially disentangled nanofibers;
a moisture content of less than or equal to 30% by weight; and
a bulk density of less than or equal to 0.2 g/cm³.

18. The product of claim 17, wherein:
the bulk density is less than 0.1 g/cm³.

19. The product of claim 17 or claim 18, wherein:
the bulk density is less than 0.05 g/cm³.

20. The product of any one of claims 17 to 19, wherein:
the nanofibers are readily dispersed in air.

21. The product of any one of claims 17 to 20, wherein:
the nanofibers have an average CSF value of less than 10.

22. The product of any one of claims 17 to 21, wherein:
the nanofibers have an average CSF value of less than 5.

23. A non-woven web comprising the product of any one of claims 17 to 22.

24. The web of claim 23, wherein the web is a wet-laid product.

25. The web of claim 23, wherein the web is an air-laid product.

26. The web of claim 23, wherein the web is a carded product.

27. The web of claim 23, wherein the web is a hydroentanged product.

28. A method of producing a non-woven web comprising:
incorporating the product of any one of claims 17 to 27 in a furnish of a paper machine.

29. A method of coating a wet-laid non-woven web comprising:
applying a coating comprising the product of any one of claims 17 to 28 to the wet-laid non-woven web.

30. The method of claim 29, wherein:
said applying comprises depositing the product of any one of claims 17 to 27 with a second head box of a paper machine.
